(19) United States
(12) Patent Application Publication
(10) Pub. No.: US 2017/0325507 A1
(43) Pub. Date: Nov. 16, 2017

(54) TEMPERATURE MONITORING AND CONTROL DEVICE AND METHOD FOR ATOMIZER HEATING WIRE AND ELECTRONIC CIGARETTE

(71) Applicant: HUIZHOU KIMREE TECHNOLOGY CO., LTD., Huizhou, Guangdong (CN)

(72) Inventor: Zhiyong Xiang, Dongguan, Guangdong (CN)

(21) Appl. No.: 15/529,987

(22) PCT Filed: Nov. 28, 2014
(86) PCT No.: PCT/CN2014/092461

§ 371 Date: May 25, 2017

(51) Int. Cl. A24F 47/00; H05B 1/02; F22B 1/28

(52) U.S. Cl. CPC A24F 47/008; F22B 1/284; H05B 1/02

(57) ABSTRACT

A temperature monitoring and control device and method for an atomizer heating wire, and an electronic cigarette. The temperature monitoring and control device comprises a temperature signal generation unit and a signal processing unit. The temperature signal generation unit comprises a heating wire, a first end wire and a second end wire; the first and second end wires are made of different conductor materials; when the heating wire generates heat, an electromotive force signal is generated. The signal processing unit is configured for controlling to reduce an atomizing power of the heating wire or turn off a power supply circuit of the heating wire when the current temperature value is greater than or equal to a preset value. The technical effect is to keep the temperature of the heating wire in a suitable temperature range.

### FIELD OF THE INVENTION

The present application relates to the field of electronic cigarettes, and more particularly relates to a temperature monitoring and control device and method for an atomizer heating wire and an electronic cigarette.

### BACKGROUND OF THE INVENTION

Electronic cigarettes are common electronic products of simulation of cigarettes and mainly used for smoking cessation and replacing cigarettes; the electronic cigarette mainly comprises a battery assembly and an atomizer assembly; when a smoking action of the user is detected, the battery supplies power for the atomizer assembly to make the atomizer assembly be in work state; after the atomizer assembly starts working, a heating wire heats, e-liquid is heated to be evaporated and atomized to form aerial fog simulating smoke, which makes the user feel like smoking a real cigarette when smoking the electronic cigarette.

The main ingredients of the e-liquid are propylene glycol, vegetable glycerin, purified water, nicotine and essence; the atomization temperatures of the e-liquid are different according to the different ingredients of the e-liquid, such atomization temperature of some e-liquid is from 260° C. to 270° C., while some is from 270° C. to 280° C., when the e-liquid is atomized during the corresponding temperature range, the taste of the aerial fog is pure. However, most of the atomizer assembly of the electronic cigarette at present consists of heating wire, wire, copper wire and other parts; when the heating wire heats, the temperature of the heating wire cannot be acquired, while the temperature of the heating wire rises continually during using process, when the temperature is too high, the heating wire generates peculiar taste and effects the taste of the user; besides when the temperature of the e-liquid rises to a certain degree, hazardous substances are generated to harm the health of the user.

That is to say, the electronic cigarette at present cannot monitor and control the temperature of the atomizer heating wire, causing that when the temperature of the heating wire is too high, the heating wire generates peculiar taste or makes the temperature of the e-liquid be too high to generate hazardous substances to effect the taste of the user even to harm the health of the user.

### SUMMARY OF THE INVENTION

The present application is to provide a temperature monitoring and control device and method for an atomizer heating wire and to provide an electronic cigarette, aiming at the defect that electronic cigarette cannot monitor or control the temperature of the atomizer heating wire, causing that when the temperature of the heating wire is too high, the heating wire generates peculiar taste or makes the temperature of the e-liquid be too high to generate hazardous substances to effect the taste of the user even to harm the health of the user, and present application realizes the technical effect of monitoring and controlling the temperature of the heating wire to make sure the temperature will not be too high when the atomizer heating wire heats.

In one aspect, the present application provides a temperature monitoring and control device of an atomizer heating wire for an electronic cigarette, the temperature monitoring and control device comprises:

a temperature signal generation unit, comprising a heating wire configured for atomizing e-liquid, a first end wire and a second end wire, one end of the first end wire and one end of the second end wire are connected to the heating wire; the first end wire and the second end wire are made of different conductor materials, an impedance of the second end wire is lower than an impedance of the heating wire, and the second end wire is configured for transmitting electric energy to the heating wire to atomize the e-liquid; when the heating wire generates heat, an electromotive force signal is generated at the other end of the first end wire and the other end of the second end wire and is transmitted to a signal processing unit;

the signal processing unit, which is configured for acquiring a current temperature value of the heating wire according to the electromotive force signal and controlling to reduce an atomizing power of the heating wire or turn off a power supply circuit of the heating wire when the current temperature value is greater than or equal to a preset value.

Preferably, the signal processing unit comprises:

a signal amplifier, which is configured for amplifying the electromotive force signal to acquire an amplified electromotive force signal;

a signal processor, which is configured for processing the amplified electromotive force signal to acquire the current temperature value of the heating wire and generating a control instruction configured for controlling to reduce the atomizing power of the heating wire or turn off the power supply circuit of the heating wire when the current temperature value is greater than or equal to the preset value;

a heating wire drive, which is configured for executing the control instruction to reduce the atomizing power of the heating wire or turn off the power supply circuit of the heating wire.

Preferably, one end of the first end wire is connected to a first end socket of the heating wire, one end of the second end wire is connected to a second end socket opposite to the first end socket of the heating wire, the other end of the first end wire is connected to the heating wire drive, the other end of the second end wire is connected to ground to form the power supply circuit of the heating wire; the end of the first end wire opposite to the heating wire and the end of the second end wire opposite to the heating wire are further connected to the signal amplifier to form a temperature monitoring circuit of the heating wire.

Preferably, the heating wire and the first end wire are integrated; the heating wire and the first end wire are alloy wires of which impedance is higher than the impedance of the second end wire.

Preferably, the heating wire is a metal wire of which impedance is higher than impedance of the first end wire and the second end wire, the first end wire and the second end wire are low-impedance metal wires with different materials.

Preferably, the signal processor comprises:

a pulse signal generation module, which is configured for generating a pulse control signal;

a signal processing module, which is configured for turning off the power supply circuit of the heating wire periodically based on the pulse control signal and monitoring and processing the amplified electromotive force signal to acquire the current temperature value of the heating wire, the signal processing module is further configured for generating and sending the control instruction configured for controlling to reduce the atomizing power of the heating wire or turn off the power supply circuit of the heating wire when the current temperature value is greater than or equal to the preset value.

Preferably, one end of the first end wire and one end of the second end wire are both connected to a first end socket of the heating wire; a second end socket of the heating wire opposite to the first end socket is connected to one end of an electric wire, the other end of the electric wire is connected to the heating wire drive, the other end of the second end wire is connected to ground to form the power supply circuit of the heating wire; the end of the first end wire opposite to the heating wire and the end of the second end wire opposite to the heating wire are further connected to the signal amplifier to form a temperature monitoring circuit of the heating wire.

In another aspect, the present application provides a temperature monitoring and control method of an atomizer heating wire for an electronic cigarette, an atomizer of the electronic cigarette comprises: a heating wire configured for atomizing e-liquid, a first end wire and a second end wire, one end of the first end wire and one end of the second end wire are connected to the heating wire; the first end wire and the second end wire are made of different conductor materials, an impedance of the second end wire is lower than an impedance of the heating wire, and the second end wire is configured for transmitting electric energy to the heating wire to atomize the e-liquid; the method comprises following steps:

S1, generating an electromotive force signal at the other end of the first end wire and the other end of the second end wire when the heating wire generates heat;

S2, acquiring a current temperature value of the heating wire according to the electromotive force signal and controlling to reduce an atomizing power of the heating wire or turn off a power supply circuit of the heating wire when the current temperature value is greater than or equal to a preset value.

Preferably, the step S2 comprises:

S21, amplifying the electromotive force signal to acquire an amplified electromotive force signal;

S22, processing the amplified electromotive force signal to acquire the current temperature value of the heating wire and generating and sending a control instruction configured for controlling to reduce the atomizing power of the heating wire or turn off the power supply circuit of the heating wire when the current temperature value is greater than or equal to the preset value;

S23, executing the control instruction to reduce the atomizing power of the heating wire or turn off the power supply circuit of the heating wire.

Preferably, the step S2 specifically is:

when one end of the first end wire is connected to a first end socket of the heating wire, and one end of the second end wire is connected to a second end socket opposite to the first end socket of the heating wire, periodically monitoring and processing the amplified electromotive force signal to acquire the current temperature value of the heating wire, generating and sending the control instruction configured for controlling to reduce the atomizing power of the heating wire or turn off the power supply circuit of the heating wire when the current temperature value is greater than or equal to the preset value.

In a third aspect, the present application provides an electronic cigarette, the electronic cigarette comprises: a battery assembly and an atomizer assembly;

the atomizer assembly comprises: a temperature signal generation unit comprising: a heating wire configured for atomizing e-liquid, a first end wire and a second end wire, one end of the first end wire and one end of the second end wire are connected to the heating wire; the first end wire and the second end wire are made of different conductor materials, an impedance of the second end wire is lower than an impedance of the heating wire, and the second end wire is configured for transmitting electric energy to the heating wire to atomize the e-liquid; when the heating wire generates heat, an electromotive force signal is generated at the other end of the first end wire and the other end of the second end wire;

the electronic cigarette further comprises: a signal processing unit defined in the battery assembly or the atomizer assembly, the signal processing unit is configured for receiving the electromotive force signal, acquiring a current temperature value of the heating wire according to the electromotive force signal and controlling to reduce an atomizing power of the heating wire or turn off a power supply circuit of the heating wire when the current temperature value is greater than or equal to a preset value.

Preferably, the signal processing unit comprises:

a signal amplifier, which is configured for amplifying the electromotive force signal to acquire an amplified electromotive force signal;

a signal processor, which is configured for processing the amplified electromotive force signal to acquire the current temperature value of the heating wire and generating a control instruction configured for controlling to reduce the atomizing power of the heating wire or turn off the power supply circuit of the heating wire when the current temperature value is greater than or equal to the preset value;

a heating wire drive, which is configured for executing the control instruction to reduce the atomizing power of the heating wire or turn off the power supply circuit of the heating wire.

Preferably, one end of the first end wire is connected to a first end socket of the heating wire, one end of the second end wire is connected to a second end socket opposite to the first end socket of the heating wire, the other end of the first end wire is connected to the heating wire drive, the other end of the second end wire is connected to ground to form the power supply circuit of the heating wire; the end of the first end wire opposite to the heating wire and the end of the second end wire opposite to the heating wire are further connected to the signal amplifier to form a temperature monitoring circuit of the heating wire.

Preferably, the heating wire and the first end wire are integrated; the heating wire and the first end wire are alloy wires of which impedance is higher than the impedance of the second end wire.

Preferably, the heating wire is a metal wire of which impedance is higher than impedance of the first end wire and the second end wire, the first end wire and the second end wire are low-impedance metal wires with different materials.

Preferably, the signal processor comprises:

a pulse signal generation module, which is configured for generating a pulse control signal;

a signal processing module, which is configured for turning off the power supply circuit of the heating wire periodically based on the pulse control signal and monitoring and processing the amplified electromotive force signal to acquire the current temperature value of the heating wire, the signal processing module is further configured for generating and sending the control instruction configured for controlling to reduce the atomizing power of the heating wire or turn off the power supply circuit of the heating wire when the current temperature value is greater than or equal to the preset value.

Preferably, one end of the first end wire and one end of the second end wire are both connected to a first end socket of the heating wire; a second end socket of the heating wire opposite to the first end socket is connected to one end of an electric wire, the other end of the electric wire is connected to the heating wire drive, the other end of the second end wire is connected to ground to form the power supply circuit of the heating wire; the end of the first end wire opposite to the heating wire and the end of the second end wire opposite to the heating wire are further connected to the signal amplifier to form a temperature monitoring circuit of the heating wire.

Preferably, the signal processing unit is further configured for controlling to conduct the power supply circuit of the heating wire when the power supply circuit of the heating wire is disconnected and a smoking trigger signal is acquired and the current temperature value is lower than the preset value.

When implementing the one or more technical solutions of present application, the following advantageous effects can be achieved:

As in present application, the temperature monitoring and control device comprieses: a temperature signal generation unit and a signal processing unit; the temperature signal generation unit comprises a heating wire configured for atomizing e-liquid, a first end wire and a second end wire, one end of the first end wire and one end of the second end wire are connected to the heating wire; the first end wire and the second end wire are made of different conductor materials (thermocouple matericals), an impedance of the second end wire is lower than an impedance of the heating wire, and the second end wire is configured for transmitting electric energy to the heating wire to atomize the e-liquid; when the heating wire generates heat, the electromotive force signal is generated at the other end (cold end) of the first end wire and the other end (cold end) of the second end wire and is transmitted to a signal processing unit; the signal processing unit, which is configured for acquiring a current temperature value of the heating wire according to the electromotive force signal and controlling to reduce an atomizing power of the heating wire or turn off a power supply circuit of the heating wire when the current temperature value is greater than or equal to a preset value. That is to say, the present application makes use of the temperature measurement principle of the thermocouple, two end wires (the first end wire and the second end wire) with different thermocouple matericals are arranged on the atomizer heating wire; when the heating wire heats, the two end wires and the heating wire form a closed circuit and acquire heat from the heating wire; as the matericals of the two end wires are different, a temperature difference is formed between the two end wires, an electric current will go through the circuit, and the electromotive force signal is generated at the cold ends (the ends which are not connected to the heating wire) of the two end wires; then the signal processing unit processes the electromotive force signal to acquire the current temperature value of the heating wire, and compares the current temperature value with the preset value, when the current temperature value is greater than or equal to the preset value, the signal processing unit controls to turn off the power supply circuit of the heating wire to make the temperature of the heating wire no longer rise and be in a suitable range; the present application effectively solutes the technical problem that the electronic cigarette in the prior art cannot monitor or control the temperature of the heating wire, which causes the heating wire to generate peculiar taste or make the temperature of the e-liquid be too high to generate hazardous substances to effect the taste of the user even to harm the health of the user when the temperature of the heating wire is too high, the present application, the present application realizes the monitoring and controlling of the temperature of the heating wire to make the temperature be in a suitable range when the atomizer heating wire heats, the smoke atomized by the e-liquid in this temperature range has good taste and will not generate hazardous substances to improve the experience of the user; besides, the internal circuit source of the electronic cigarette at present have been fully made use of in present application, the circuit supplies power for the heating wire and monitors the temperature of the heating wire at the same time, the temperature monitoring circuit is simple, convenient, saves cost and effectively prevents the drawback of easily occuring shortcircuit when an addition temperature monitoring circuit is arranged in the electronic cigarette.

### BRIEF DESCRIPTION OF THE DRAWINGS

FIG. 1 is a structural schematic diagram of a temperature monitoring and control device for an atomizer heating wire of a first embodiment of present application;

FIG. 2 is a structural schematic diagram of a temperature monitoring and control device for the atomizer heating wire of a second embodiment of present application;

FIG. 3A-3B are structural schematic diagrams of a temperature monitoring and control device for the atomizer heating wire of which thermocouple end wires are provided at two ends of the heating wire of a first embodiment of present application;

FIG. 4A-4B are structural schematic diagrams of a temperature monitoring and control device for the atomizer heating wire of which thermocouple end wires are provided at two ends of the heating wire of a second embodiment of present application;

FIG. 5 is a structural schematic diagram of a temperature monitoring and control device for an atomizer heating wire of a third embodiment of present application;

FIG. 6A-6B are structural schematic diagrams of a temperature monitoring and control device for the atomizer heating wire of which thermocouple end wires are provided at one end of the heating wire of an embodiment of present application;

FIG. 7 is a flow diagram of a temperature monitoring and control method for an atomizer heating wire of a first embodiment of present application;

FIG. 8 is a flow diagram of a temperature monitoring and control method for an atomizer heating wire of a second embodiment of present application;

FIG. 9A-9B are structural schematic diagrams of two kinds of electronic cigarettes of embodiments of present application.

### DETAILED DESCRIPTION OF THE PREFERRED EMBODIMENT

To overcome the defect that electronic cigarette cannot monitor or control the temperature of the atomizer heating wire, causing that when the temperature of the heating wire is too high, the heating wire generates peculiar taste or makes the temperature of the e-liquid be too high to generate hazardous substances to effect the taste of the user even to harm the health of the user, the present application provides a temperature monitoring and control device for an atomizer heating wire to realize the technical effect of monitoring and controlling the temperature of the heating wire to make sure the temperature will not be too high when the atomizer heating wire generates heat.

In order to solute the above-mentioned technical problems, the general ideas of embodiments of present application are as follows:

the present application provides a temperature monitoring and control device of an atomizer heating wire for an electronic cigarette, the temperature monitoring and control device comprises: a temperature signal generation unit, comprising a heating wire configured for atomizing e-liquid, a first end wire and a second end wire, one end of the first end wire and one end of the second end wire are connected to the heating wire; the first end wire and the second end wire are made of different conductor materials, an impedance of the second end wire is lower than an impedance of the heating wire, and the second end wire is configured for transmitting electric energy to the heating wire to atomize the e-liquid; when the heating wire generates heat, an electromotive force signal is generated at cold end of the first end wire and cold end of the second end wire and is transmitted to a signal processing unit; the signal processing unit, which is configured for acquiring a current temperature value of the heating wire according to the electromotive force signal and controlling to reduce an atomizing power of the heating wire or turn off a power supply circuit of the heating wire when the current temperature value is greater than or equal to a preset value.

Thus it can be seen, in the present application, two end wires (the first end wire and the second end wire) made of different conductor materials (thermocouple materials) are arranged on the atomizer heating wire by making use of the temperature measurement principle of the thermocouple; when the heating wire heats, the two end wires and the heating wire form a closed circuit and acquire heat from the heating wire; as the materials of the two end wires are different, a temperature difference is formed between the two end wires, an electric current will go through the circuit, and the electromotive force signal is generated at the cold ends (the ends which are not connected to the heating wire) of the two end wires; then the signal processing unit processes the electromotive force signal to acquire the current temperature value of the heating wire, and compares the current temperature value with the preset value, when the current temperature value is greater than or equal to the preset value, the signal processing unit controls to turn off the power supply circuit of the heating wire to make the temperature of the heating wire no longer rise and be in a suitable range; the present application effectively solutes the technical problem that the electronic cigarette in the prior art cannot monitor or control the temperature of the heating wire, which causes the heating wire to generate peculiar taste or make the temperature of the e-liquid be too high to generate hazardous substances to effect the taste of the user even to harm the health of the user when the temperature of the heating wire is too high, the present application realizes the monitoring and controlling of the temperature of the heating wire to make the temperature be in a suitable range when the atomizer heating wire generates heat, the smoke atomized by the e-liquid in this temperature range has good taste and will not generate hazardous substances to improve the experience of the user; besides, the internal circuit source of the electronic cigarette at present have been fully made use of in present application, the circuit supplies power for the heating wire and monitors the temperature of the heating wire at the same time, the temperature monitoring circuit is simple, convenient, saves cost and effectively prevents the drawback of easily occurring short-circuit when an addition temperature monitoring circuit is arranged in the electronic cigarette.

To make the technical feature, objective and effect of the present application be understood more clearly, now the specific implementation of the present application is described in detail with reference to the accompanying drawings and embodiments, understandably the embodiments and the specific technical features of the embodiments are detailed description of present application but not to limit the present application, the embodiments and the technical features of the embodiments can combine with each other without conflict.

### The First Embodiment

With reference to FIG. 1, the embodiment of present application provides a temperature monitoring and control device of an atomizer heating wire for an electronic cigarette, the temperature monitoring and control device comprises:

a temperature signal generation unit 10, comprising a heating wire 101 configured for atomizing e-liquid, a first end wire 102 and a second end wire 103, one end of the first end wire 102 and one end of the second end wire 103 are connected to the heating wire 101; the first end wire 102 and the second end wire 103 are made of different conductor materials, an impedance of the second end wire 103 is lower than an impedance of the heating wire 101, and the second end wire 103 is configured for transmitting electric energy to the heating wire 101 to atomize the e-liquid; when the heating wire 101 generates heat, an electromotive force signal is generated at the other end of the first end wire 102 and the other end of the second end wire 103 and is transmitted to a signal processing unit 20;

the signal processing unit 20, which is configured for acquiring a current temperature value of the heating wire 101 according to the electromotive force signal and controlling to reduce an atomizing power of the heating wire 101 or turn off a power supply circuit of the heating wire 101 when the current temperature value is greater than or equal to a preset value.

Specifically, with reference to FIG. 1 again, one end of the first end wire 102 and one end of the second end wire 103 are connected to the heating wire 101, when the heating wire 101 is electrified to heats, as the effect of thermal transmission, the temperature of the first end wire 102 and the second end wire 103 both rise, while the first end wire 102 and the second end wire 103 are made of different conductor materials, specifically thermocouple materials, such as the first end wire 102 is made of copper, the second end wire 103 is made of metal, etc, the temperature of the first end wire 102 and the temperature of the second end wire 103 are different, a temperature difference is formed between the two end wires, according to the principle of the thermocouple, an electric current is formed in the circuit, and the electromotive force signal is generated at the other ends (cold ends which are not connected to the heating wire) of the first end wire 102 and the second end wire 103.

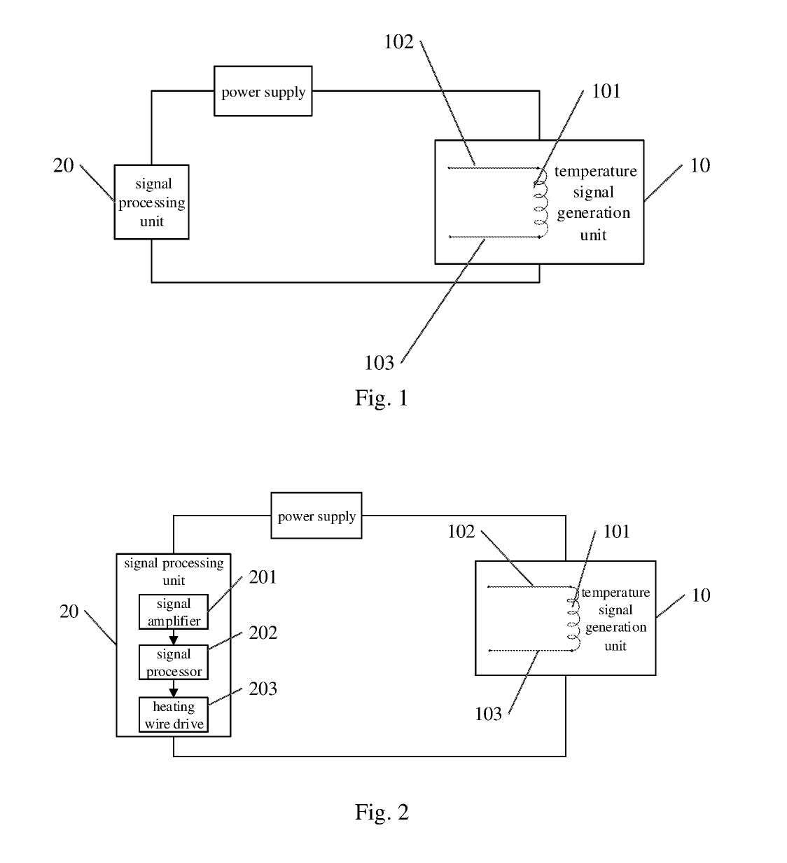

Furtherly, with reference to FIG. 2, the signal processing unit 20 comprises:

a signal amplifier 201, which is configured for amplifying the electromotive force signal to acquire an amplified electromotive force signal;

a signal processor 202, which is configured for processing the amplified electromotive force signal to acquire the current temperature value of the heating wire 101 and generating a control instruction configured for controlling to reduce the atomizing power of the heating wire 101 or turn off the power supply circuit of the heating wire 101 when the current temperature value is greater than or equal to the preset value;

a heating wire drive 203, which is configured for executing the control instruction to reduce the atomizing power of the heating wire 101 or turn off the power supply circuit of the heating wire 101.

Specifically, usually the electromotive force signal generated at the cold ends of the first end wire 102 and the second end wire 103 are weak, in order to make the electromotive force signal be recognized easily, the electromotive force signal needs to be amplified to acquire the amplified electromotive force signal; then the amplified electromotive force signal is furtherly processed to acquire the current temperature of the heating wire 101; finally the supply voltage of the heating wire 101 is controlled based on the current temperature. Thus is can be seen, the present application relates to two aspects about power supplying of the heating wire 101 and the temperature monitoring.

In the specific implementation process, according to the connection way between the heating wire 101 and the first and second end wires (102,103) and the materials of the heating wire 101 and the first and second end wires (102,103) of the temperature signal generation unit 10, there are at least three following implementations:

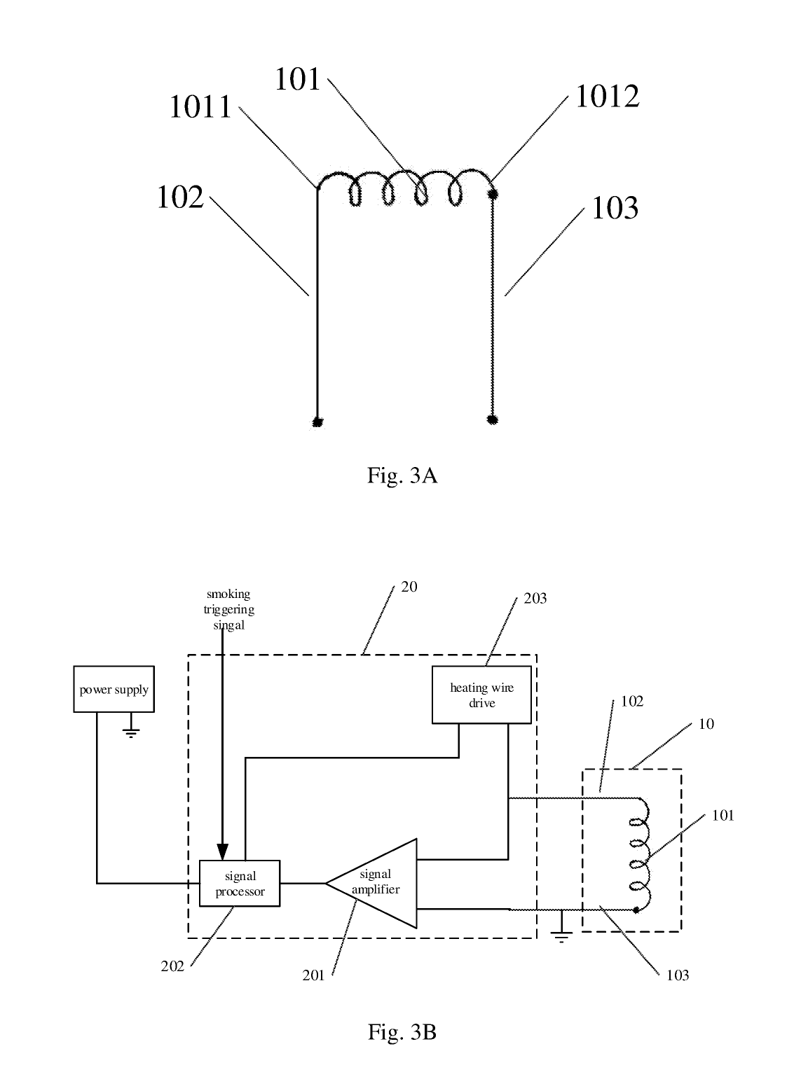

1) a first implementation, with reference to FIG. 3A and FIG. 3B, one end of the first end wire 102 is connected to a first end socket 1011 of the heating wire 101, one end of the second end wire 103 is connected to a second end socket 1012 opposite to the first end socket 1011 of the heating wire 101, the other end of the first end wire 102 is connected to the heating wire drive 203, the other end of the second end wire 103 is connected to ground, to form the power supply circuit of the heating wire 101; the end of the first end wire 102 opposite to the heating wire 101and the end of the second end wire 103 opposite to the heating wire 101 are further connected to the signal amplifier 201 to form a temperature monitoring circuit of the heating wire 101. Besides, the heating wire 101 and the first end wire 102 are integrated; the heating wire 101 and the first end wire 102 are alloy wires such as nickel-chromium, iron-chromium and nickel-chromium silicon, etc, impedance of the alloy wires is higher than the impedance of the second end wire 103; the second end wire 103 is low-impedance metal wire such as nickel, metal or copper-nickel alloy, etc.

Specifically, as shown in FIG. 3B, the operating principles of the first implementation are: the signal processing unit 20 is defined on the power supply circuit of the heating wire 101, in one aspect, when a smoke action has been detected, the signal processor 202 acquires a smoking triggering signal and controls the heating wire drive 203 to work, the power supply circuit of the heating wire 101 is conducted, the heating wire 101 is electrified to heat, a temperature difference is generated between the end of the first end wire 102 (nickel-chromium material) and the end of the second end wire 103 (constantan material), according to the temperature measurement principle of the thermocouple, the electromotive force signal is generated at the cold ends of the high-impedance alloy wire and the low-impedance metal wire; in another aspect, the signal inputting end of the signal amplifier 201 is connected to the cold ends of the first end wire 102 and the second end wire 103 to acquire the electromotive force signal and amplify the electromotive force signal, the furtherly amplified electromotive force signal is transmitted to the signal processor 202 to be processed to acquire the current temperature value of the heating wire 101 and then the supply voltage of the heating wire 101 is controlled based on the temperature value, when the current temperature value is greater than or equal to the preset value, the heating wire drive 203 is controlled to reduce the atomizing power of the heating wire 101, or the heating wire drive 203 is controlled to stop working to turn off the power supply circuit of the heating wire 101 to prevent the temperature of the heating wire 101 being too high to effect the taste of the smoke or generate hazardous substances.

In this implementation, the heating wire 101 and a wire connected to one end of the heating wire 101 (the first end wire 102) are integrated, the integrated wire is made of alloy wire with high- impedance, the other end of the heating wire 101 is made of a metal wire with low-impedance, a thermocouple temperature sensor made of two different metal wires can heat and additionally can monitor the temperature; that is to say the heating wire 101 is not only used as a heating component of the atomizer but also integrated with the first end wire 102 to be used as a component of the thermocouple temperature sensor. The material combinations of the first end wire 102 and the second end wire 103 are “nickel-chromium and constantan”, in the specific implementation process, the materials can be other combinations and are not listed one by one here.

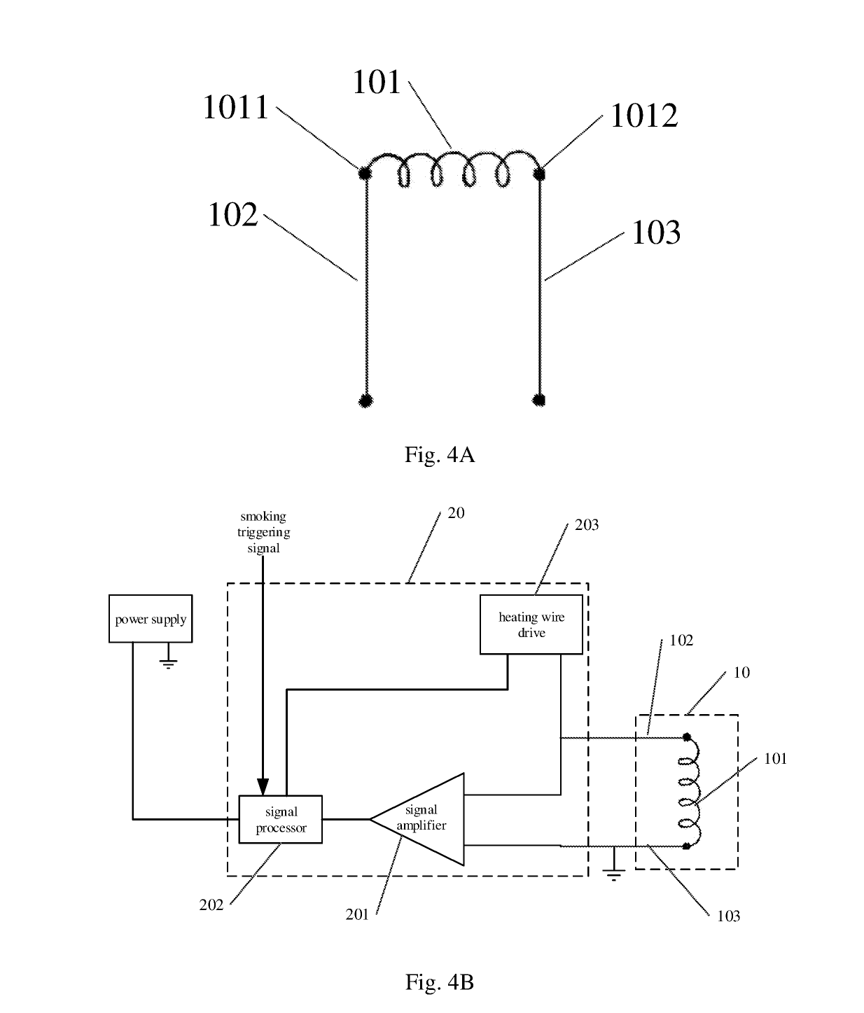

2) a second implementation, with reference to FIG. 4A and FIG. 4B, one end of the first end wire 102 is connected to a first end socket 1011 of the heating wire 101, one end of the second end wire 103 is connected to a second end socket 1012 opposite to the first end socket 1011 of the heating wire 101, the other end of the first end wire 102 is connected to the heating wire drive 203, the other end of the second end wire 103 is connected to ground, to form the power supply circuit of the heating wire 101; the end of the first end wire 102 opposite to the heating wire 101 and the end of the second end wire 103 opposite to the heating wire 101 are further connected to the signal amplifier 201 to form a temperature monitoring circuit of the heating wire 101. Besides, the materials of the heating wire 101, the first end wire 102 and the second end wire 103 are different from each other, specifically, the heating wire 101 is metal wire of which impedance is higher than the impedance of the first end wire 102 and the impedance of the second end wire 103, the first end wire 102 and the second end wire 103 are low-impedance metal wires (such as nickle, silver or copper, etc) with different materials, specific resistance of the first end wire 102 and the second end wire 103 is preferably low than 2.5×10⁻⁸ Ω·m. The first end wire 102 and the second end wire 103 are made of low-impedance metal wires with different materials and are connected to two ends of the heating wire 101 to be used as wires, that is to say the first end wire 102 and the second end wire 103 can supply power for the heating wire 101 and can furtherly monitor the temperature of the heating wire 101.

Specifically, the working principle shown in FIG. 4B is same with the working principle shown in FIG. 3B and it is no longer detailed here. The difference is the heating wire 101 is made of high-impedance metal wires (comprising high-impedance alloy wires and high-impedance non-alloy wires) in this implementation and can select and use nichrome; the first end wire 102 and the second end wire 103 can be made of nickle and silver respectively; of course, in the specific implementation process, the materials of the heating wire 101, the first end wire 102 and the second end wire 103 can be other combinations and are not listed one by one here.

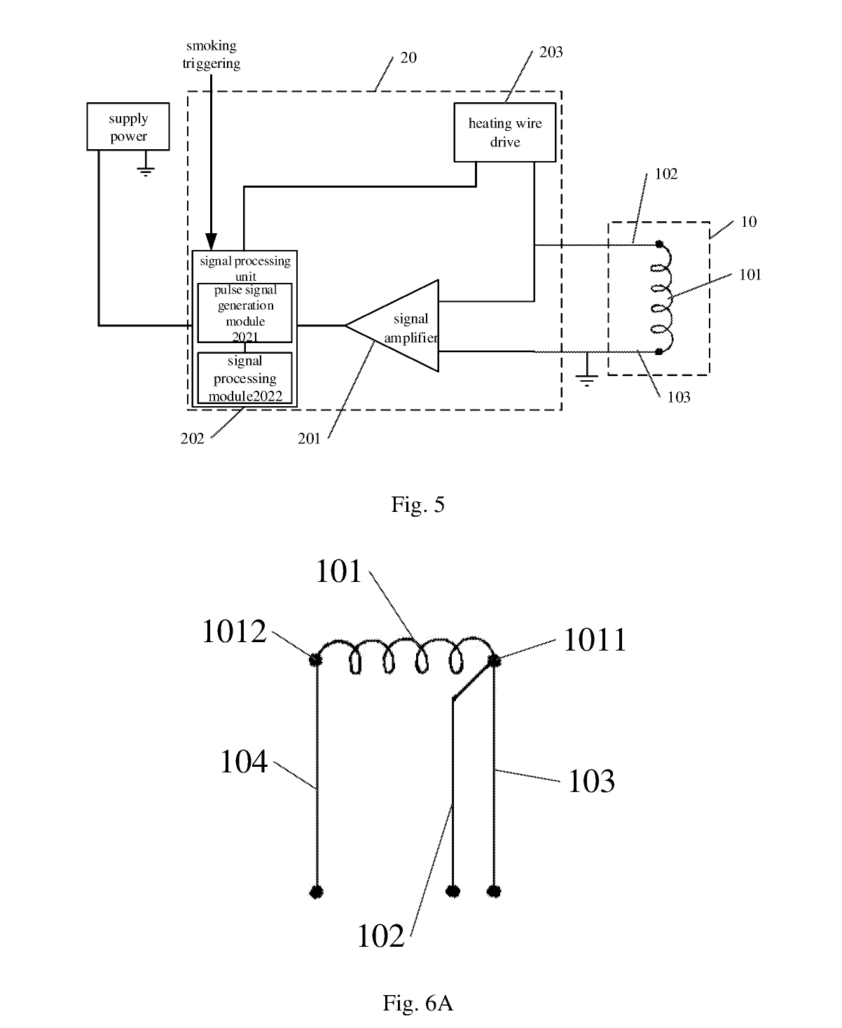

It should be noted that in the implementation 1) and implementation 2) above-mentioned, as the first end wire 102 and the second end wire 103 are used as a supplying power wire for the heating wire 101 and furtherly configured for transmitting a thermocouple signal (the electromotive force signal) when the first end wire 102 and the second end wire 103 form a heating circuit with the heating wire 101, in order to prevent the electromotive force signal for monitoring temperature from conflicting with the supply voltage, the signal processing unit 20 can be set as turning off the power supply when monitoring the temperature of the heating wire 101, with reference to FIG. 5, in this implementation, the signal processor 202 comprises: a pulse signal generation module 2021, which is configured for generating a pulse control signal; a signal processing module 2022, which is configured for turning off the power supply circuit of the heating wire 101 periodically based on the pulse control signal and monitoring and processing the amplified electromotive force signal to acquire the current temperature value of the heating wire 101, the signal processing module 2022 is further configured for generating and sending the control instruction configured for controlling to reduce the atomizing power of the heating wire 101 or turn off the power supply circuit of the heating wire 101 when the current temperature value is greater than or equal to the preset value.

Specifically, the pulse signal generation module 2021 can be a Pulse Width Modulation (PWM) controller, when the PWM controller outputs a high level signal, the signal processing module 2022 controls to turn off the power supply for the heating wire 101; specifically the signal processing module 2022 can control to disconnect the connection to the heating wire drive 203 or to send a control instruction of stopping driving to the heating wire drive 203; at the same time, the signal processing module 2022 receives the amplified electromotive force signal amplified by the signal amplifier 201 and processes the amplified electromotive force signal. When the PWN controller outputs a low level signal and the current temperature value is greater than or equal to the preset value, the signal processing module 2022 controls to disconnect the power supply circuit of the heating wire 101 or controls to conduct the power supply circuit of the heating wire 101 and reduce the atomizing power of the heating wire 101 at the same time. When the PWN controller outputs a low level signal and the current temperature value is less than the preset value, the signal processing module 2022 controls to disconnect the communication circuit with the signal amplifier 201 and controls to turn on the power supply for the heating wire 101 or increase the atomizing power of the heating wire 101. Of course, other way can be taken to prevent the temperature monitoring electromotive force signal from conflicting with the supply voltage, and it is no longer detailed here.

In the specific implementation process, when the signal processing module 2022 monitors that the current temperature value of the heating wire 101 is greater than or equal to the preset value and controls to turn off the power supply circuit of the heating wire 101, the signal processing module 2022 can still periodically monitor the temperature of the heating wire 101 based on the pulse control signal, and when the temperature value of the heating wire 101 is less than the preset value, the signal processing module 2022 controls to turn on the power supply for the heating wire 101. It is noted that the time of turning off the power supply for the heating wire 101 to monitor the temperature of the heating wire 101 is very short, the monitoring of temperature is hardly effected.

3) a third implementation, with reference to FIG. 6A and 6B, one end of the first end wire 102 and one end of the second end wire 103 are both connected to a first end socket 1011 of the heating wire 101; a second end socket 1012 of the heating wire 101 opposite to the first end socket 1011 is connected to one end of an electric wire 104, the other end of the electric wire 104 is connected to the heating wire drive 203, the other end of the second end wire 103 is connected to ground, to form the power supply circuit of the heating wire 101; the end of the first end wire 102 opposite to the heating wire 101 and the end of the second end wire 103 opposite to the heating wire 101 are further connected to the signal amplifier 201 to form a temperature monitoring circuit of the heating wire 101. The electric wire 104 can be made of common material, such as copper conducting wire of which inner conductor is bare copper or tinned copper, etc; of course other conductive material can be used and it is not limited here.

Specifically, the working principle shown in FIG. 6B is basically the same as the working principle in FIG. 3B and FIG. 4B, the same working principle is forming a thermocouple circuit between the first end wire 102 and the second end wire 103, acquiring an electromotive force signal from the cold ends of the two end wires and then determining a current temperature value of the heating wire 101based on the electromotive force signal, furtherly, controlling the supply voltage of the heating wire 101 based on the current temperature value.

The differences between the implementation shown in FIG. 6B and the implementations of FIG. 3B and FIG. 4B are: \textcircled{1} in this implementation, the first end wire 102 and the second end wire 103 are made of metal wires (comprising alloy wires and non-alloy wires) with different materials, such as copper, metal and constantan, etc, the options of the materials of the two end wires are more; \textcircled{2} in this implementation, the first end wire 102 and the second end wire 103 are connected to one end of the heating wire 101 to obtain heat and form a thermocouple circuit, the power supply circuit of the heating wire 101 is separated from the temperature monitoring circuit, when the signal processing unit 20 monitors the temperature of the heating wire 101, the power supply circuit can still be in conducting state, the control logic is relatively simple.

It is noted that, in the implementation shown in FIG. 6B, when the heating wire 101 works, as the electric current is too high, a tiny pressure drop is formed on the first end wire 102 and the second end wire 103, for instance the actual electromotive force signal outputted from the cold ends of the first end wire 102 and the second end wire 103 should be 20 mv, but because of the tiny pressure drop (such as 1 mv), the electromotive force signal monitored by the signal processor 202 is 21 mv (in order to explain it clearly, the signal amplifier 201 is not considered here), which may cause a deviation of the monitored temperature of the heating wire 101, to this, when implementing this implementation, in order to accurately monitor the temperature of the heating wire 101, a compensating circuit can be used to counteract the pressure drop, for instance, dividing the voltage at the input end of the signal processor 202 configured for receiving the electromotive force signal to eliminate the tiny pressure drop to make the electromotive force signal input to the signal processor 202 be corresponding with the actual electromotive force signal outputted from the cold ends of the first end wire 102 and the second end wire 103; there is a lot methods of circuit compensation and no longer detailed here.

Besides, in the specific implementation process, when the electronic cigarette comprises two main parts: a battery assembly and an atomizer assembly, the temperature signal generation unit 10 can be defined in the atomizer assembly of the electronic cigarette, the signal processing unit 20 can be defined in the battery assembly of the electronic cigarette; of course, the location of the signal processing unit 20 can be defined according to the specific conditions and is not limited here.

To sum up, in the present application, two end wires (the first end wire and the second end wire) made of different conductor materials (thermocouple materials) are arranged on the atomizer heating wire by making use of the temperature measurement principle of the thermocouple; when the heating wire heats, the two end wires and the heating wire form a closed circuit and acquire heat from the heating wire; as the materials of the two end wires are different, a temperature difference is formed between the two end wires, an electric current will go through the circuit, and the electromotive force signal is generated at the cold ends (the ends which are not connected to the heating wire) of the two end wires; then the signal processing unit processes the electromotive force signal to acquire the current temperature value of the heating wire, and compares the current temperature value with the preset value, when the current temperature value is greater than or equal to the preset value, the signal processing unit controls to turn off the power supply circuit of the heating wire to make the temperature of the heating wire no longer rise and be in a suitable range; the present application realizes the monitoring and controlling of the temperature of the heating wire to make the temperature be in a suitable range when the atomizer heating wire generates heat, the smoke atomized by the e-liquid in this temperature range has good taste and will not generate hazardous substances to improve the experience of the user; besides, the internal circuit source of the electronic cigarette at present have been fully made use of in present application, the circuit supplies power for the heating wire and monitors the temperature of the heating wire at the same time, the temperature monitoring circuit is simple, convenient, saves cost and effectively prevents the drawback of easily occurring short-circuit when an addition temperature monitoring circuit is arranged in the electronic cigarette.

### The Second Embodiment

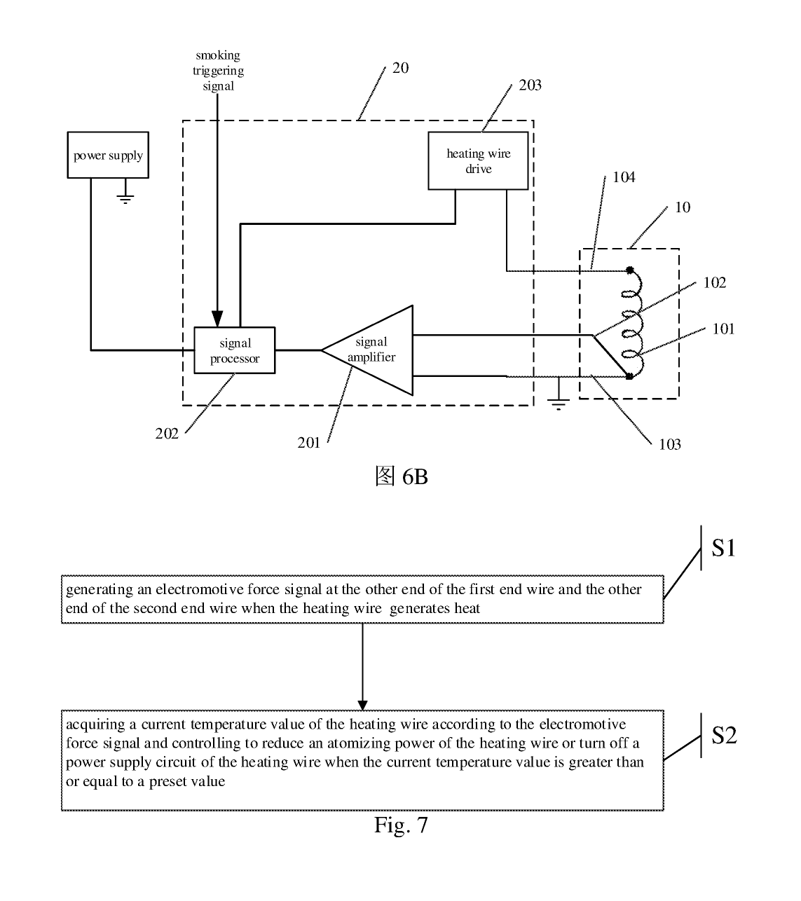

Based on the same inventive concept, with reference to FIG. 7, the embodiment of present application further provides a temperature monitoring and control method of an atomizer heating wire for an electronic cigarette, an atomizer of the electronic cigarette comprises: a heating wire 101 configured for atomizing e-liquid, a first end wire 102 and a second end wire 103, one end of the first end wire 102 and one end of the second end wire 103 are connected to the heating wire 101; the first end wire 102 and the second end wire 103 are made of different conductor materials, an impedance of the second end wire 103 is lower than an impedance of the heating wire 101, and the second end wire 103 is configured for transmitting electric energy to the heating wire 101 to atomize the e-liquid; the method comprises following steps:

S1, generating an electromotive force signal at the other end of the first end wire 102 and the other end of the second end wire 103 when the heating wire 101 generates heat;

S2, acquiring a current temperature value of the heating wire 101 according to the electromotive force signal and controlling to reduce an atomizing power of the heating wire 101 or turn off a power supply circuit of the heating wire 101 when the current temperature value is greater than or equal to a preset value.

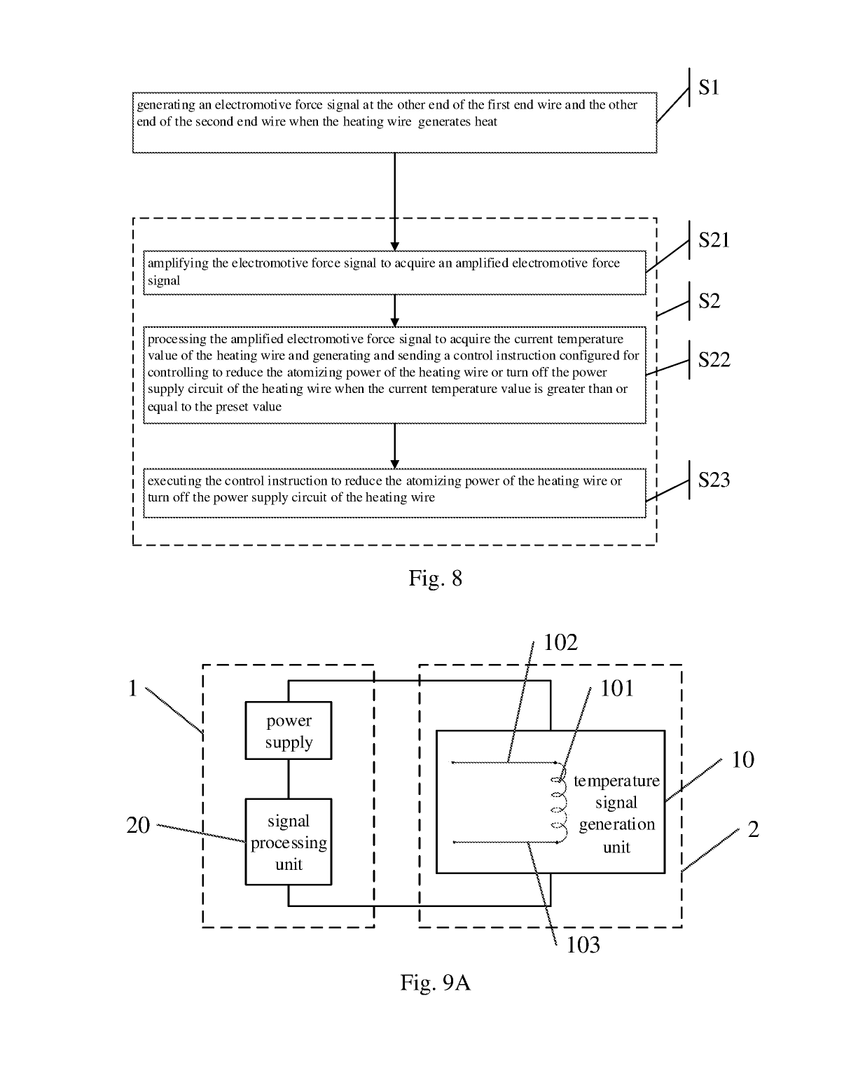

Furtherly, with reference to FIG. 8, the step S2 comprises:

S21, amplifying the electromotive force signal to acquire an amplified electromotive force signal;

S22, processing the amplified electromotive force signal to acquire the current temperature value of the heating wire 101 and generating and sending a control instruction configured for controlling to reduce the atomizing power of the heating wire 101 or turn off the power supply circuit of the heating wire 101 when the current temperature value is greater than or equal to the preset value;

S23, executing the control instruction to reduce the atomizing power of the heating wire 101 or turn off the power supply circuit of the heating wire 101.

In the specific implementation process, the step S2 specifically is:

when one end of the first end wire 102 is connected to a first end socket 1011of the heating wire 101, and one end of the second end wire 103 is connected to a second end socket 1012 opposite to the first end socket 1011 of the heating wire 101, periodically monitoring and processing the amplified electromotive force signal to acquire the current temperature value of the heating wire 101, generating and sending the control instruction configured for controlling to reduce the atomizing power of the heating wire 101 or turn off the power supply circuit of the heating wire 101 when the current temperature value is greater than or equal to the preset value.

According to the above description, the temperature monitoring and control method is applied to the temperature monitoring and control device, thus the implementation process has been detailed in implementation principles of the one or more embodiments of the temperature monitoring and control device and is no longer detailed here.

### The Third Embodiment

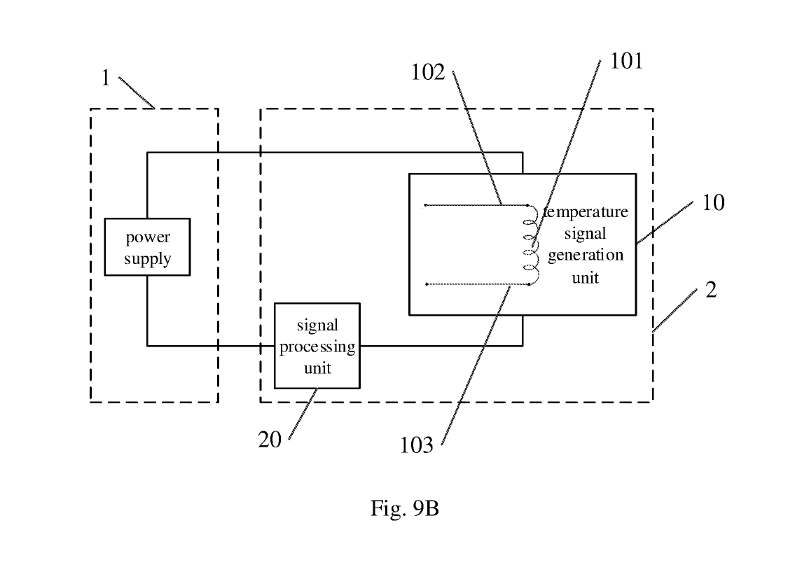

Based on the same inventive concept, with reference to FIG. 9A and 9B, the embodiments of present application further provides an electronic cigarette, the electronic cigarette comprises: a battery assembly 1 and an atomizer assembly 2;

the atomizer assembly 2 comprises: a temperature signal generation unit 10 comprising: a heating wire 101 configured for atomizing e-liquid, a first end wire 102 and a second end wire 103, one end of the first end wire 102 and one end of the second end wire 103 are connected to the heating wire 101; the first end wire 102 and the second end wire 103 are made of different conductor materials, an impedance of the second end wire 103 is lower than an impedance of the heating wire 101, and the second end wire 103 is configured for transmitting electric energy to the heating wire 101 to atomize the e-liquid; when the heating wire 101 generates heat, an electromotive force signal is generated at the other end of the first end wire 102 and the other end of the second end wire 103;

the electronic cigarette further comprises: a signal processing unit 20 defined in the battery assembly 1 or the atomizer assembly 2, the signal processing unit 20 is configured for receiving the electromotive force signal, acquiring a current temperature value of the heating wire 101 according to the electromotive force signal and controlling to reduce an atomizing power of the heating wire 101 or turn off a power supply circuit of the heating wire 101 when the current temperature value is greater than or equal to a preset value.

In the specific implementation process, with reference to FIG. 2, the signal processing unit 20 comprises:

a signal amplifier 201, which is configured for amplifying the electromotive force signal to acquire an amplified electromotive force signal;

a signal processor 202, which is configured for processing the amplified electromotive force signal to acquire the current temperature value of the heating wire 101 and generating a control instruction configured for controlling to reduce the atomizing power of the heating wire 101 or turn off the power supply circuit of the heating wire 101 when the current temperature value is greater than or equal to the preset value;

a heating wire drive 203, which is configured for executing the control instruction to reduce the atomizing power of the heating wire 101 or turn off the power supply circuit of the heating wire 101.

In the specific implementation process, according to the connection way between the heating wire 101 and the first and second end wires (102,103) and the materials of the heating wire 101 and the first and second end wires (102,103) of the temperature signal generation unit 10, there are at least three following implementations:

1) With reference to FIG. 3A and FIG. 3B, one end of the first end wire 102 is connected to a first end socket 1011 of the heating wire 101, one end of the second end wire 103 is connected to a second end socket 1012 opposite to the first end socket 1011 of the heating wire 101, the other end of the first end wire 102 is connected to the heating wire drive 203, the other end of the second end wire 103 is connected to ground, to form the power supply circuit of the heating wire 101; the end of the first end wire 102 opposite to the heating wire 10l and the end of the second end wire 103 opposite to the heating wire 101 are further connected to the signal amplifier 201 to form a temperature monitoring circuit of the heating wire 101. Besides, the heating wire 101 and the first end wire 102 are integrated; the heating wire 101 and the first end wire 102 are alloy wires such as nickel-chromium, iron-chromium and nickel-chromium silicon, etc, impedance of the alloy wires is higher than the impedance of the second end wire 103; the second end wire 103 is low-impedance metal wire such as nickel, metal or copper-nickel alloy, etc.

2) With reference to FIG. 4A and FIG. 4B, one end of the first end wire 102 is connected to a first end socket 1011 of the heating wire 101, one end of the second end wire 103 is connected to a second end socket 1012 opposite to the first end socket 1011 of the heating wire 101, the other end of the first end wire 102 is connected to the heating wire drive 203, the other end of the second end wire 103 is connected to ground, to form the power supply circuit of the heating wire 101; the end of the first end wire 102 opposite to the heating wire 101 and the end of the second end wire 103 opposite to the heating wire 101 are further connected to the signal amplifier 201 to form a temperature monitoring circuit of the heating wire 101. Besides, the materials of the heating wire 101, the first end wire 102 and the second end wire 103 are different from each other, specifically, the heating wire 101 is metal wire of which impedance is higher than the impedance of the first end wire 102 and the second end wire 103, the first end wire 102 and the second end wire 103 are low-impedance metal wires (such as nickle, silver or copper, etc) with different materials. The first end wire 102 and the second end wire 103 are made of low-impedance metal wires with different materials and are connected to two ends of the heating wire 101 to be used as wires, that is to say the first end wire 102 and the second end wire 103 can supply power for the heating wire 101 and can furtherly monitor the temperature of the heating wire 101.

It should be noted that in the implementation 1) and implementation 2) above-mentioned, as the first end wire 102 and the second end wire 103 are used as the supplying power wire for the heating wire 101 and furtherly configured for transmitting a thermocouple signal (the electromotive force signal) when the first end wire 102 and the second end wire 103 form a heating circuit with the heating wire 101, in order to prevent the temperature monitoring electromotive force signal from conflicting with the supply voltage, the signal processing unit 20 can be set as turning off the power supply when monitoring the temperature of the heating wire 101, with reference to FIG. 5, in this implementation, the signal processor 202 comprises: a pulse signal generation module 2021, which is configured for generating a pulse control signal; a signal processing module 2022, which is configured for turning off the power supply circuit of the heating wire 101 periodically based on the pulse control signal and monitoring and processing the amplified electromotive force signal to acquire the current temperature value of the heating wire 101, the signal processing module 2022 is further configured for generating and sending the control instruction configured for controlling to reduce the atomizing power of the heating wire 101 or turn off the power supply circuit of the heating wire 101 when the current temperature value is greater than or equal to the preset value.

3) With reference to FIG. 6A and 6B, one end of the first end wire 102 and one end of the second end wire 103 are both connected to a first end socket 1011 of the heating wire 101; a second end socket 1012 of the heating wire 101 opposite to the first end socket 1011 is connected to one end of an electric wire 104, the other end of the electric wire 104 is connected to the heating wire drive 203, the other end of the second end wire 103 is connected to ground, to form the power supply circuit of the heating wire 101; the end of the first end wire 102 opposite to the heating wire 101 and the end of the second end wire 103 opposite to the heating wire 101 are further connected to the signal amplifier 201 to form a temperature monitoring circuit of the heating wire 101. The electric wire 104 can be made of common materials, such as copper conducting wire of which inner conductor is bare copper or tinned copper, etc; of course other conductive material can be used and it is not limited here.

In the specific implementation process, the signal processing unit 20 is further configured for controlling to conduct the power supply circuit of the heating wire 101 when the power supply circuit of the heating wire 101 is disconnected and a smoking trigger signal is acquired and the current temperature value is lower than the preset value.

Based on the above description, the electronic cigarette comprises the temperature monitoring and control device of the heating wire, thus the one or more embodiments of the electronic cigarette are the same with one or more embodiments of the temperature monitoring and control device and are no longer detailed here.

One skilled in the art should know that, the embodiments of present application can be provided as methods, systems, or computer program products. Therefore, the present application can be in the forms of complete hardware embodiments, complete software embodiments, or combination of software and hardware embodiments. Moreover, the present application can be in the forms of computer program products implemented on one or more computer available storage media (including but not limited to disk storage, CD-ROM, optical storage, etc) comprising program code available for computers.

The present application is described with reference to the methods, the equipments (systems), the flow charts and/or block diagrams of computer programs of embodiments of present application. Understandably each process and/or box of the flow charts and/or block diagrams, and the combination of the processes and/or box of the process flow diagrams and/or block diagrams can be realized through the computer program instructions. The computer program instructions can be provided to general computers, special-purpose computer, embedded processors or other processors of devices processing programmable data to produce a machine, which makes the instructions executed by computers or other processors of devices processing programmable data generate devices configured for realizing the designated functions of one or more process of the process flow charts and/or one or more boxes of the block diagrams.

These program instructions can also be stored in the computer readable storages which can guide computers or other programmable data processing equipments to work in a particular way, which makes the instructions stored in the computer readable storage generate manufactures comprising instructions devices, the instructions devices realize the designated functions of one or more process of the process flow charts and/or one or more boxes of the block diagrams.

The computer program instructions can be loaded into computers or other programmable data processing equipments, which makes the computers or other programmable devices perform a series of steps to produce the processing of computer implementation, and to provide steps configured for realizing the designated functions of one or more process of the process flow charts and/or one or more boxes of the block diagrams for the instructions executed in computers or other programmable devices.

Although the preferable embodiments of present application have been described, one skilled in the art can change or amend these embodiments once they know the basis creativity, therefore, the attached claims are interpreted as comprising preferable embodiments and, the all change or amendment belongs to present application.

Obviously, those ordinary skills in the art can also make many modifications without breaking away from the subject of the present application and the protection scope of the claims. All these modifications belong to the protection of the present application.

1. A temperature monitoring and control device of an atomizer heating wire for an electronic cigarette, wherein the temperature monitoring and control device comprises:
a temperature signal generation unit (10), comprising a heating wire (101) configured for atomizing e-liquid, a first end wire (102) and a second end wire (103), one end of the first end wire (102) and one end of the second end wire (103) are connected to the heating wire (101);
the first end wire (102) and the second end wire (103) are made of different conductor materials, an impedance of the second end wire (103) is lower than an impedance of the heating wire (101), and the second end wire (103) is configured for transmitting electric energy to the heating wire (101) to atomize the e-liquid; when the heating wire (101) generates heat, an electromotive force signal is generated at the other end of the first end wire (102) and the other end of the second end wire (103) and is transmitted to a signal processing unit (20);
the signal processing unit (20), which is configured for acquiring a current temperature value of the heating wire (101) according to the electromotive force signal and controlling to reduce an atomizing power of the heating wire (101) or turn off a power supply circuit of the heating wire (101) when the current temperature value is greater than or equal to a preset value.

2. The temperature monitoring and control device of an atomizer heating wire according to claim 1, wherein the signal processing unit (20) comprises:
a signal amplifier (201), which is configured for amplifying the electromotive force signal to acquire an amplified electromotive force signal;
a signal processor (202), which is configured for processing the amplified electromotive force signal to acquire the current temperature value of the heating wire (101) and generating a control instruction configured for controlling to reduce the atomizing power of the heating wire (101) or turn off the power supply circuit of the heating wire (101) when the current temperature value is greater than or equal to the preset value;
a heating wire drive (203), which is configured for executing the control instruction to reduce the atomizing power of the heating wire (101) or turn off the power supply circuit of the heating wire (101).

3. The temperature monitoring and control device of an atomizer heating wire according to claim 2, wherein one end of the first end wire (102) is connected to a first end socket (1011) of the heating wire (101), one end of the second end wire (103) is connected to a second end socket (1012) opposite to the first end socket (1011) of the heating wire (101), the other end of the first end wire (102) is connected to the heating wire drive (203), the other end of the second end wire (103) is connected to ground, to form the power supply circuit of the heating wire (101); the end of the first end wire (102) opposite to the heating wire (101) and the end of the second end wire (103) opposite to the heating wire (101) are further connected to the signal amplifier (201) to form a temperature monitoring circuit of the heating wire (101).

4. The temperature monitoring and control device of an atomizer heating wire according to claim 3, wherein the heating wire (101) and the first end wire (102) are integrated; the heating wire (101) and the first end wire (102) are alloy wires of which impedance is higher than the impedance of the second end wire (103).

5. The temperature monitoring and control device of an atomizer heating wire according to claim 3, wherein the heating wire (101) is a metal wire of which impedance is higher than an impedance of the first end wire (102) and the impedance of the second end wire (103), the first end wire (102) and the second end wire (103) are low-impedance metal wires with different materials.

6. The temperature monitoring and control device of an atomizer heating wire according to claim 3, wherein the signal processor (202) comprises:
a pulse signal generation module (2021), which is configured for generating a pulse control signal;
a signal processing module (2022), which is configured for turning off the power supply circuit of the heating wire (101) periodically based on the pulse control signal and monitoring and processing the amplified electromotive force signal to acquire the current temperature value of the heating wire (101), the signal processing module (2022) is further configured for generating and sending the control instruction configured for controlling to reduce the atomizing power of the heating wire (101) or turn off the power supply circuit of the heating wire (101) when the current temperature value is greater than or equal to the preset value.

7. The temperature monitoring and control device of an atomizer heating wire according to claim 2, wherein one end of the first end wire (102) and one end of the second end wire (103) are both connected to a first end socket (1011) of the heating wire (101); a second end socket (1012) of the heating wire (101) opposite to the first end socket (1011) is connected to one end of an electric wire (104), the other end of the electric wire (104) is connected to the heating wire drive (203), the other end of the second end wire (103) is connected to ground, to form the power supply circuit of the heating wire (101); the end of the first end wire (102) opposite to the heating wire (101) and the end of the second end wire (103) opposite to the heating wire (101) are further connected to the signal amplifier (201) to form a temperature monitoring circuit of the heating wire (101).

8. A temperature monitoring and control method of an atomizer heating wire for an electronic cigarette, wherein an atomizer of the electronic cigarette comprises: a heating wire (101) configured for atomizing e-liquid, a first end wire (102) and a second end wire (103), one end of the first end wire (102) and one end of the second end wire (103) are connected to the heating wire (101); the first end wire (102) and the second end wire (103) are made of different conductor materials, an impedance of the second end wire (103) is lower than an impedance of the heating wire (101), and the second end wire (103) is configured for transmitting electric energy to the heating wire (101) to atomize the e-liquid;
the method comprises following steps:
S1, generating an electromotive force signal at the other end of the first end wire (102) and the other end of the second end wire (103) when the heating wire (101) generates heat;
S2, acquiring a current temperature value of the heating wire (101) according to the electromotive force signal and controlling to reduce an atomizing power of the heating wire (101) or turn off a power supply circuit of the heating wire (101) when the current temperature value is greater than or equal to a preset value.

9. The temperature monitoring and control method of an atomizer heating wire according to claim 8, wherein the step S2 comprises:
S21, amplifying the electromotive force signal to acquire an amplified electromotive force signal;
S22, processing the amplified electromotive force signal to acquire the current temperature value of the heating wire (101) and generating and sending a control instruction configured for controlling to reduce the atomizing power of the heating wire (101) or turn off the power supply circuit of the heating wire (101) when the current temperature value is greater than or equal to the preset value;
S23, executing the control instruction to reduce the atomizing power of the heating wire (101) or turn off the power supply circuit of the heating wire (101).

10. The temperature monitoring and control method of an atomizer heating wire according to claim 9, wherein the step S2 specifically is :
when one end of the first end wire (102) is connected to a first end socket (1011) of the heating wire (101), and one end of the second end wire (103) is connected to a second end socket (1012) opposite to the first end socket (1011) of the heating wire (101), periodically monitoring and processing the amplified electromotive force signal to acquire the current temperature value of the heating wire (101), generating and sending the control instruction configured for controlling to reduce the atomizing power of the heating wire (101) or turn off the power supply circuit of the heating wire (101) when the current temperature value is greater than or equal to the preset value.

11. An electronic cigarette, wherein the electronic cigarette comprises: a battery assembly (1) and an atomizer assembly (2);
the atomizer assembly (2) comprises: a temperature signal generation unit (10) comprising: a heating wire (101) configured for atomizing e-liquid, a first end wire (102) and a second end wire (103), one end of the first end wire (102) and one end of the second end wire (103) are connected to the heating wire (101); the first end wire (102) and the second end wire (103) are made of different conductor materials, an impedance of the second end wire (103) is lower than an impedance of the heating wire (101), and the second end wire (103) is configured for transmitting electric energy to the heating wire (101) to atomize the e-liquid; when the heating wire (101) generates heat, an electromotive force signal is generated at the other end of the first end wire (102) and the other end of the second end wire (103);
the electronic cigarette further comprises: a signal processing unit (20) defined in the battery assembly (1) or in the atomizer assembly (2), the signal processing unit (20) is configured for receiving the electromotive force signal, acquiring a current temperature value of the heating wire (101) according to the electromotive force signal and controlling to reduce an atomizing power of the heating wire (101) or turn off a power supply circuit of the heating wire (101) when the current temperature value is greater than or equal to a preset value.

12. The electronic cigarette according to claim 11, wherein the signal processing unit (20) comprises:
a signal amplifier (201), which is configured for amplifying the electromotive force signal to acquire an amplified electromotive force signal;
a signal processor (202), which is configured for processing the amplified electromotive force signal to acquire the current temperature value of the heating wire (101) and generating a control instruction configured for controlling to reduce the atomizing power of the heating wire (101) or turn off the power supply circuit of the heating wire (101) when the current temperature value is greater than or equal to the preset value;
a heating wire drive (203), which is configured for executing the control instruction to reduce the atomizing power of the heating wire (101) or turn off the power supply circuit of the heating wire (101).

13. The electronic cigarette according to claim 12, wherein one end of the first end wire (102) is connected to a first end socket (1011) of the heating wire (101), one end of the second end wire (103) is connected to a second end socket (1012) opposite to the first end socket (1011) of the heating wire (101), the other end of the first end wire (102) is connected to the heating wire drive (203), the other end of the second end wire (103) is connected to ground, to form the power supply circuit of the heating wire (101); the end of the first end wire (102) opposite to the heating wire (101) and the end of the second end wire (103) opposite to the heating wire (101) are further connected to the signal amplifier (201) to form a temperature monitoring circuit of the heating wire (101).

14. The electronic cigarette according to claim 13, wherein the heating wire (101) and the first end wire (102) are integrated; the heating wire (101) and the first end wire (102) are alloy wires of which impedance is higher than the impedance of the second end wire (103).

15. The electronic cigarette according to claim 13, wherein the heating wire (101) is a metal wire of which impedance is higher than an impedance of the first end wire (102) and the impedance of the second end wire (103), the first end wire (102) and the second end wire (103) are low-impedance metal wires with different materials.

16. The electronic cigarette according to claim 13, wherein the signal processor (202) comprises:
a pulse signal generation module (2021), which is configured for generating a pulse control signal;
a signal processing module (2022), which is configured for turning off the power supply circuit of the heating wire (101) periodically based on the pulse control signal and monitoring and processing the amplified electromotive force signal to acquire the current temperature value of the heating wire (101), the signal processing module (2022) is further configured for generating and sending the control instruction configured for controlling to reduce the atomizing power of the heating wire (101) or turn off the power supply circuit of the heating wire (101) when the current temperature value is greater than or equal to the preset value.

17. The electronic cigarette according to claim 12, wherein one end of the first end wire (102) and one end of the second end wire (103) are both connected to a first end socket (1011) of the heating wire (101); a second end socket (1012) of the heating wire (101) opposite to the first end socket (1011) is connected to one end of an electric wire (104), the other end of the electric wire (104) is connected to the heating wire drive (203), the other end of the second end wire (103) is connected to ground, to form the power supply circuit of the heating wire (101); the end of the first end wire (102) opposite to the heating wire (101) and the end of the second end wire (103) opposite to the heating wire (101) are further connected to the signal amplifier (201) to form a temperature monitoring circuit of the heating wire (101).

18. The electronic cigarette according to claim 16, wherein the signal processing unit (20) is further configured for controlling to conduct the power supply circuit of the heating wire (101) when the power supply circuit of the heating wire (101) is disconnected and a smoking trigger signal is acquired and the current temperature value is lower than the preset value.
